(19) United States
(12) Patent Application Publication
(10) Pub. No.: US 2018/0356059 A1
(43) Pub. Date: Dec. 13, 2018

(54) DAYLIGHTING SYSTEM, DAYLIGHTING METHOD, AND BUILDING

(71) Applicant: SHARP KABUSHIKI KAISHA, Sakai City, Osaka (JP)

(72) Inventors: SHUN UEKI, Sakai City (JP); SHUMPEI NISHINAKA, Sakai City (JP); TSUYOSHI KAMADA, Sakai City (JP); MASAHIRO TSUJIMOTO, Sakai City (JP); HIDEOMI YUI, Sakai City (JP); DAISUKE SHINOZAKI, Sakai City (JP)

(21) Appl. No.: 15/756,191

(22) PCT Filed: Aug. 31, 2016
(86) PCT No.: PCT/JP2016/075401

§ 371 Date: Feb. 28, 2018

(30) Foreign Application Priority Data
Sep. 1, 2015 (JP) 2015-172300

(51) Int. Cl. F21S 19/00; F21V 8/00; F21V 7/00; F21S 11/00

(52) U.S. Cl. CPC F21S 19/005; G02B 6/0095; F21S 11/007; F21V 7/0025; F21S 11/002; G02B 6/0055

(57) ABSTRACT

A daylighting system (1) according to one aspect of the invention includes a daylighting apparatus (2) and an artificial light source apparatus (3) that emits light toward the daylighting apparatus (2). The daylighting apparatus (2) includes a base material (4) having light transmission property, and a plurality of daylighting portions (5) that are provided on a first surface of the base material (4), have light transmission properties and reflect light incident from a light incident end surface on a reflection surface. The artificial light source apparatus (3) emits at least light that enters the daylighting portions (5) from the light incident end surface and travels toward the reflection surface.

### TECHNICAL FIELD

The present invention relates to a daylighting system, a daylighting method, and a building.

### BACKGROUND ART

A daylighting panel has been proposed that takes sunlight into a building through windows or the like of the building in PTL 1. The daylighting panel includes a panel, a base material layer formed on one surface of the panel, a plurality of unit prisms with a trapezoidal section, and a protection layer that covers the plurality of prisms.

Sunlight sequentially passes through the base material layer, one of the unit prisms, and the protection layer, and is taken into the building.

### CITATION LIST

### Patent Literature

PTL 1: Japanese Unexamined Patent Application Publication No. 2013-156554

### SUMMARY OF INVENTION

### Technical Problem

For example, when a daylighting apparatus is installed in a window of a building, during the daytime on a clear day, it is possible to illuminate the interior of the building to a desired brightness according to a design of the daylighting apparatus. However, on a cloudy day, on a rainy day, or during the nighttime, it is not possible to illuminate the interior to a desired brightness. Since in the daylighting apparatus of the related art, the amount of daylighting varies largely depending on the brightness of an outside environment, it is difficult to design the whole daylighting system combining the daylighting apparatus and the indoor illumination appliance. In addition, as seen from a person inside, when the outside environment is dark, for example, during the nighttime, since only an area of a room where the daylighting apparatus is installed looks dark, there may be some cases where the room gives the person a bad impression.

One aspect of the present invention has been made to solve the above-mentioned problem, and one object thereof is to provide a daylighting system capable of suppressing a change in the inside brightness due to a change in the brightness of the outside environment. One object of another aspect of the present invention is to provide a daylighting method capable of suppressing a change in the inside brightness due to a change in the brightness of the outside environment. One object of still another aspect of the present invention is to provide a building capable of suppressing a change in the inside brightness due to a change in the brightness of the outside environment.

### Solution to Problem

In order to achieve the above-mentioned objects, a daylighting system of one aspect of the present invention includes a daylighting apparatus and an artificial light source apparatus that emits light toward the daylighting apparatus. The daylighting apparatus includes a base material having light transmission property, and a plurality of daylighting portions that are provided on a first surface of the base material, have light transmission property, and reflect light incident from a light incident end surface on a reflection surface. The artificial light source apparatus emits at least light that enters the daylighting portions from the light incident end surface and travels toward the reflection surface.

In the daylighting system of the one aspect of the present invention, the artificial light source apparatus may emit light having directivity.

In the daylighting system of the one aspect of the present invention, the artificial light source apparatus may include a planar light emitter.

In the daylighting system of the one aspect of the present invention, the planar light emitter may include a light emitting element, and a light guide member that causes natural light or illumination light to be transmitted and that causes light emitted from the light emitting element to be incident from a light incident end surface, to be guided through an inside of the light guide member, and to be emitted from a light emission end surface. In this case, the light emission end surface of the light guide member may be substantially parallel with the first surface of the base material.

In the daylighting system of the one aspect of the present invention, a reflection portion that diffuses and reflects the light guided through the inside of the light guide member may be partially provided on a surface of the light guide member opposite to the light emission end surface.

In the daylighting system of the one aspect of the present invention, the light guide member may be provided to protrude outdoors in a direction substantially perpendicular to the base material.

A daylighting method of another aspect of the present invention includes: in a first outside environment, taking light from outdoors and introducing the light into an interior, using a daylighting apparatus including a base material having light transmission property, and a plurality of daylighting portions that are provided on a first surface of the base material, have light transmission property, and reflect light incident from a light incident end surface on a reflection surface; and when an illuminance of the light is an illuminance of a second outside environment, which is lower than an illuminance of the first outside environment, taking light emitted from an artificial light source apparatus and introducing the emitted light into the interior.

A building of still another aspect of the present invention includes a partition that partitions an interior into two adjacent spaces, and a daylighting apparatus installed on a part of the partition. The daylighting apparatus includes a base material having light transmission property, and a plurality of daylighting portions that are provided on a first surface of the base material, have light transmission property, and reflect light incident from a light incident end surface on a reflection surface.

### Advantageous Effects of Invention

According to one aspect of the present invention, a daylighting system capable of suppressing a change in the inside brightness due to a change in brightness of the outside environment can be provided. According to another aspect of the present invention, a daylighting method capable of suppressing a change in the inside brightness due to a change in the brightness of the outside environment can be provided. According to still another aspect of the present invention, a building capable of suppressing a change in the inside brightness due to a change in the brightness of the outside environment can be provided.

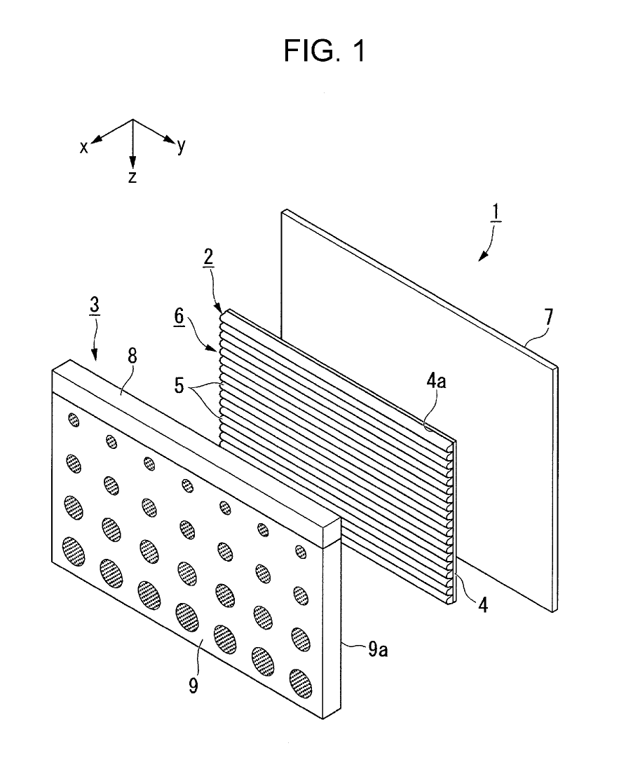

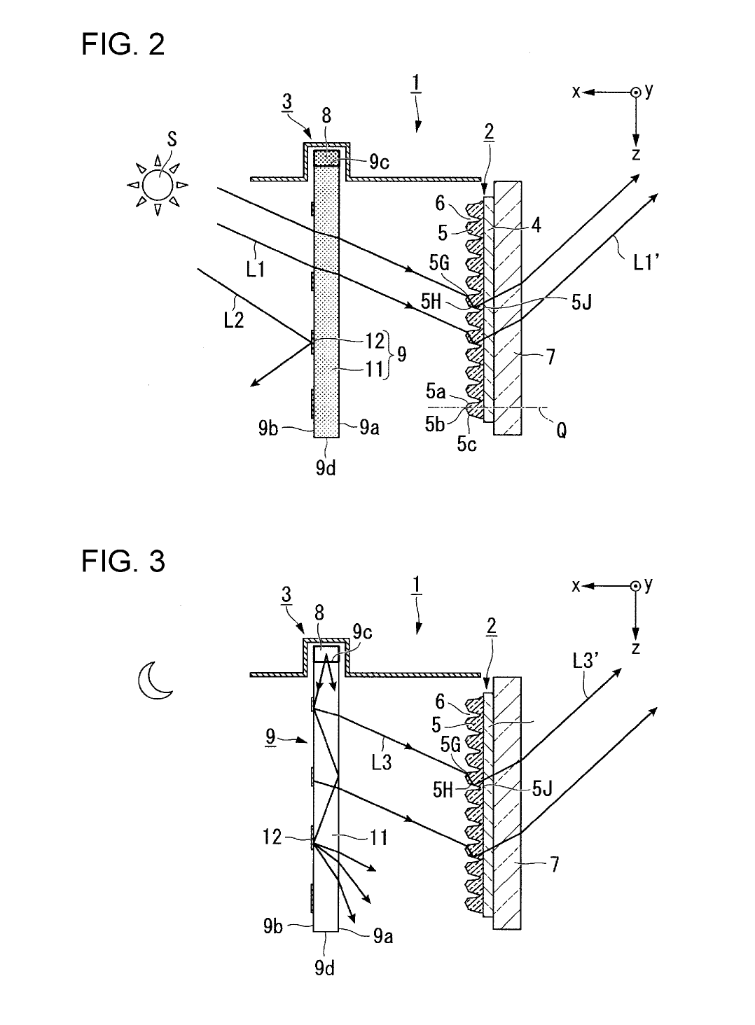

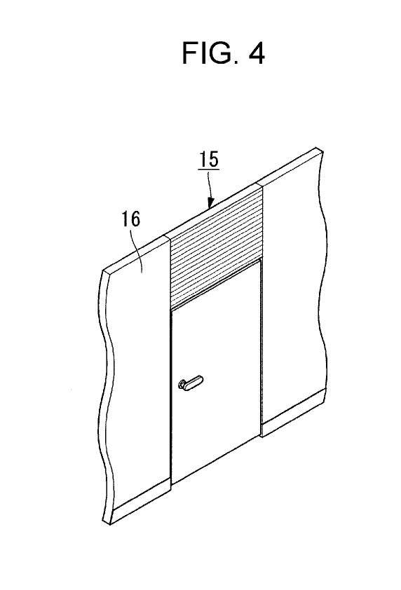

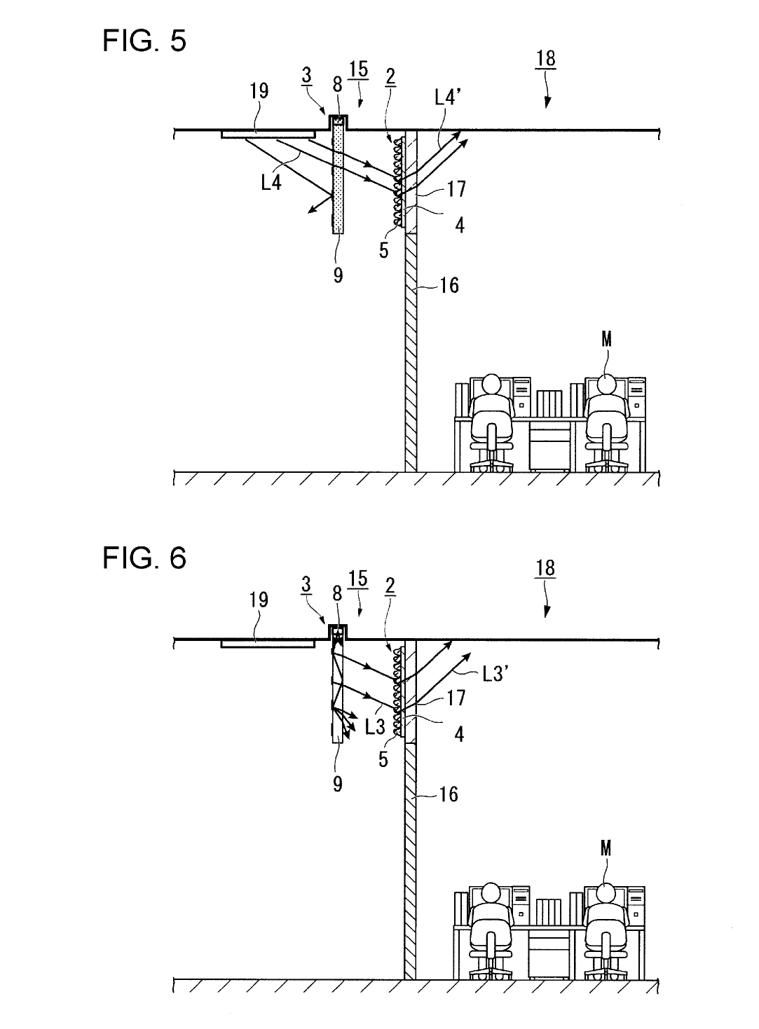

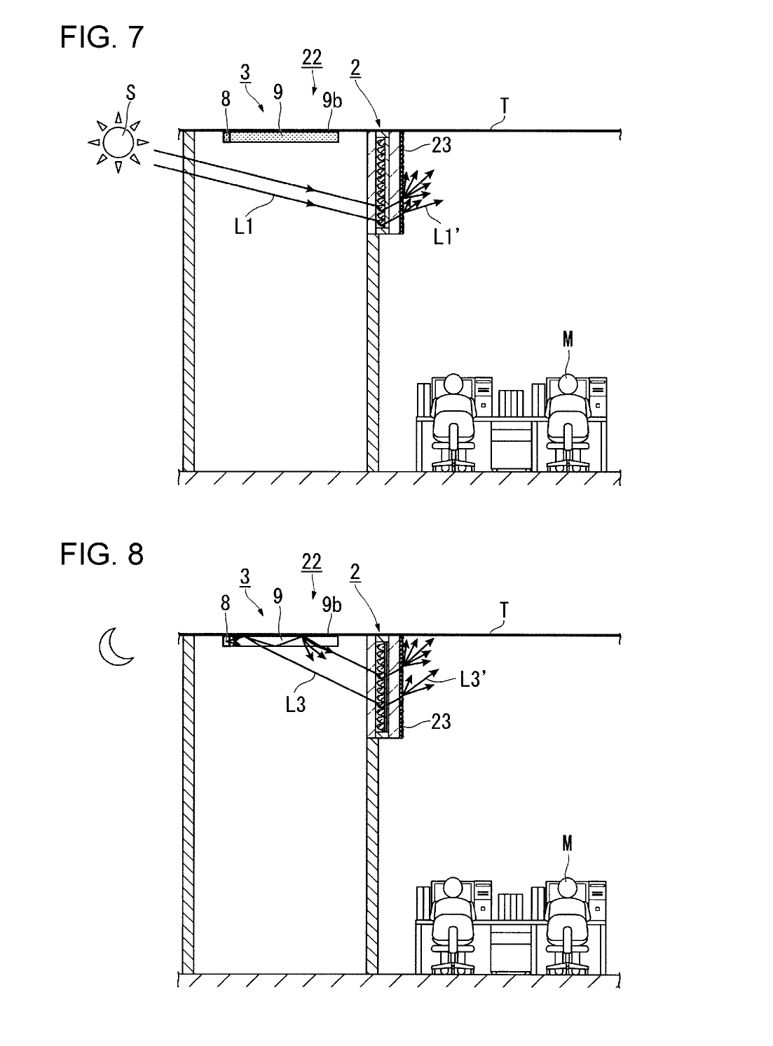

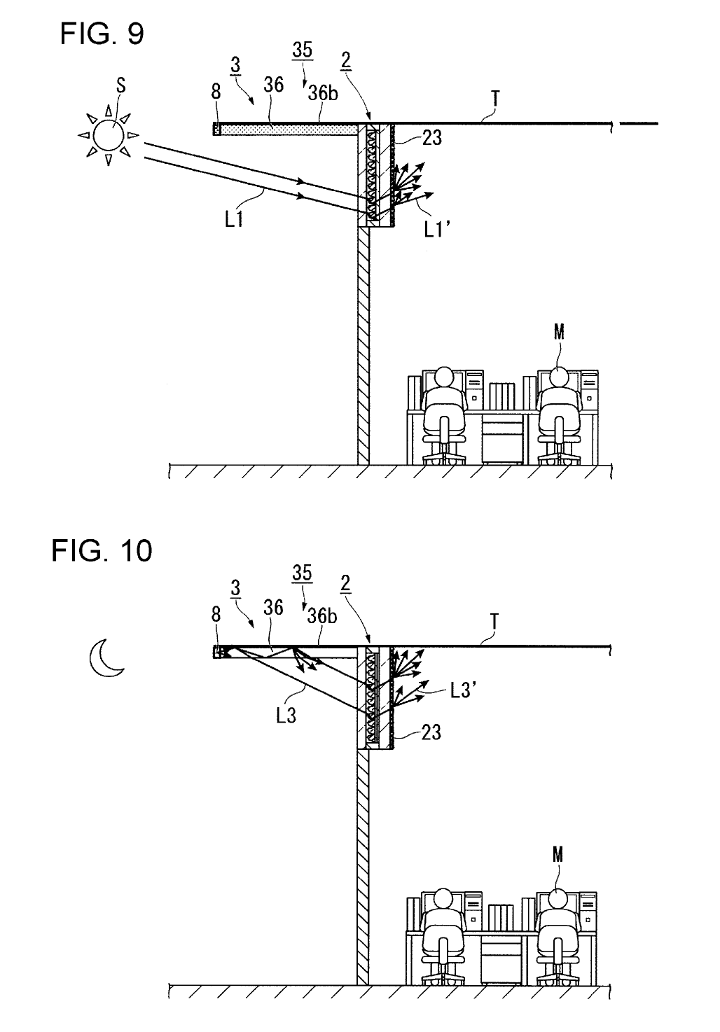

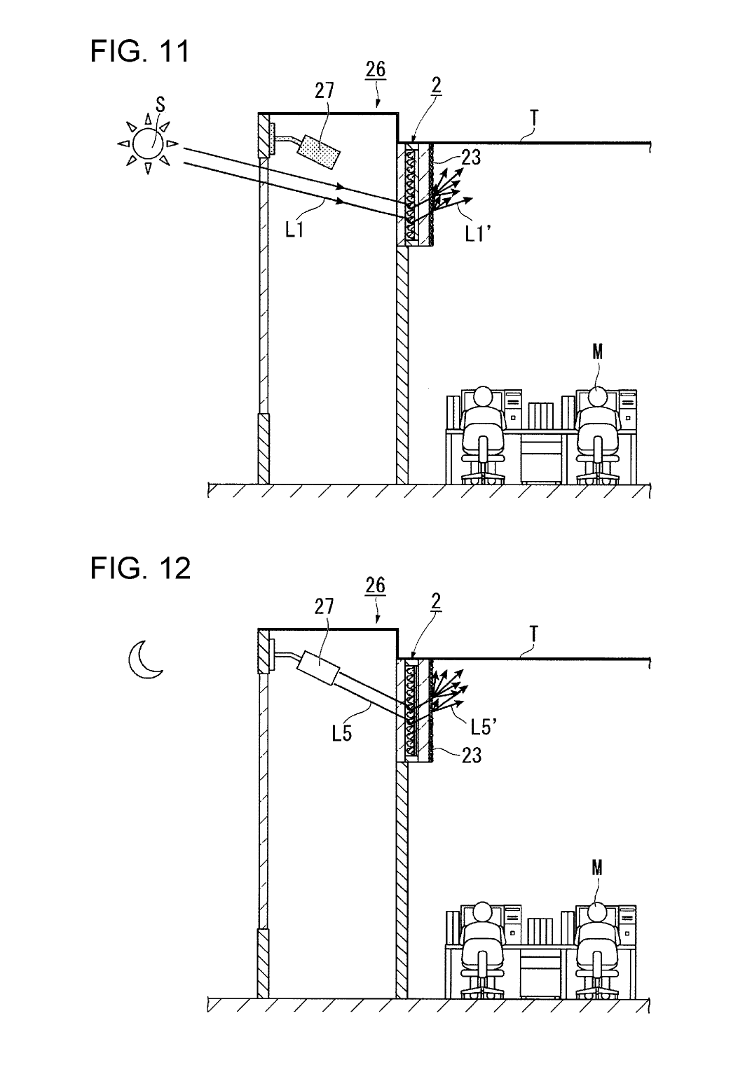

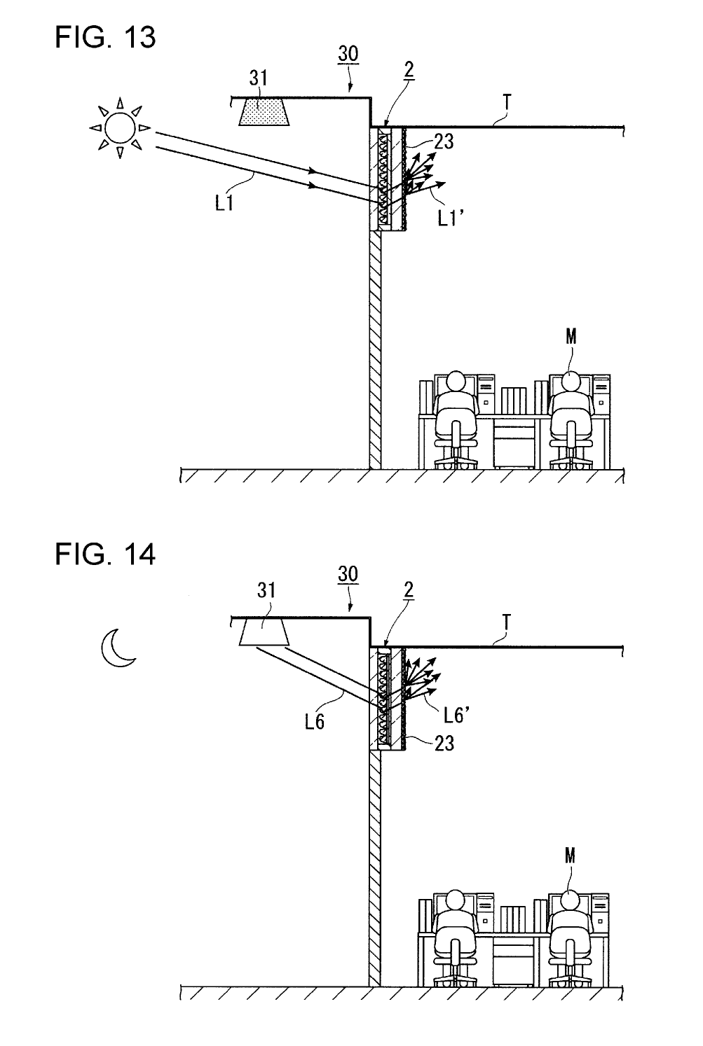

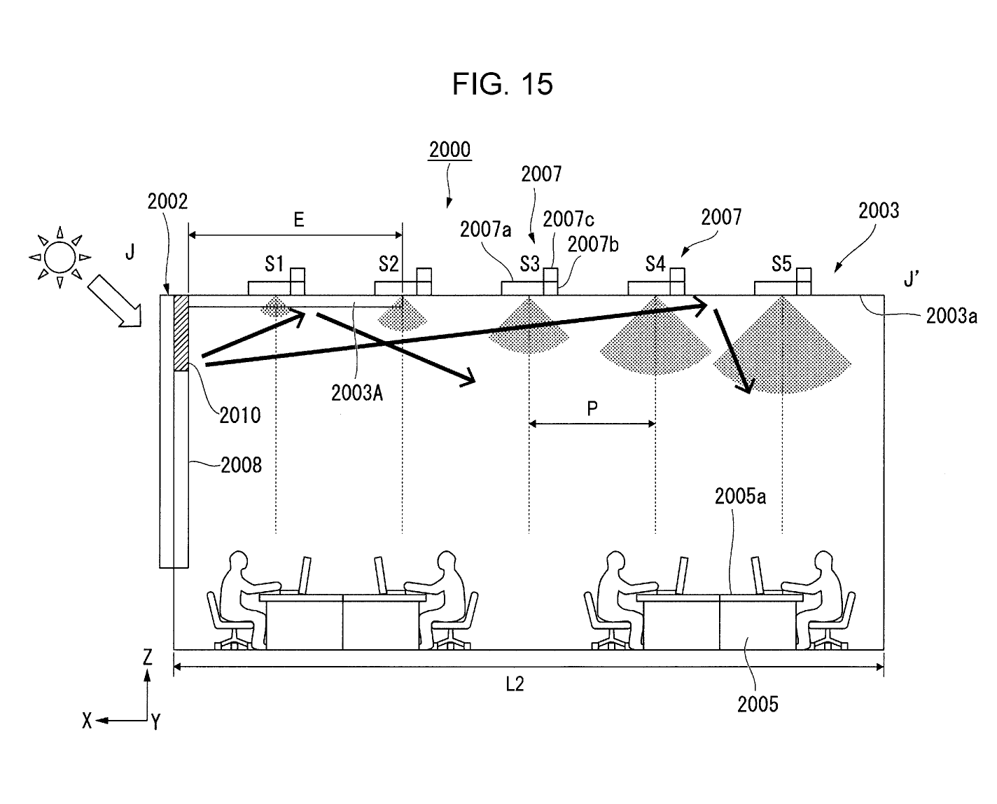

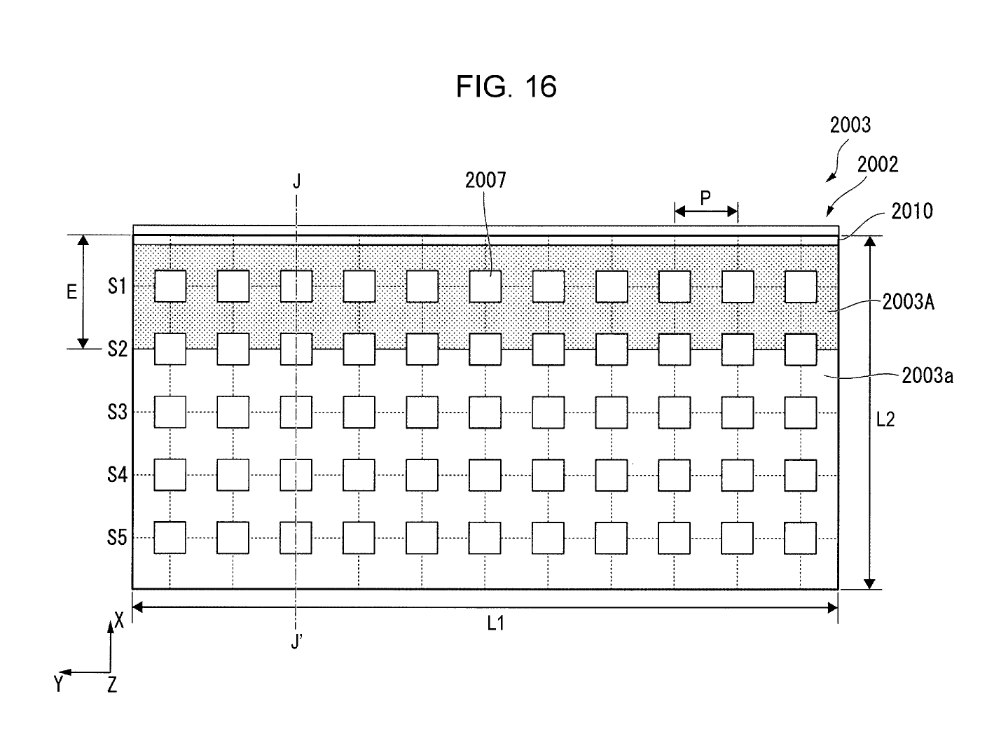

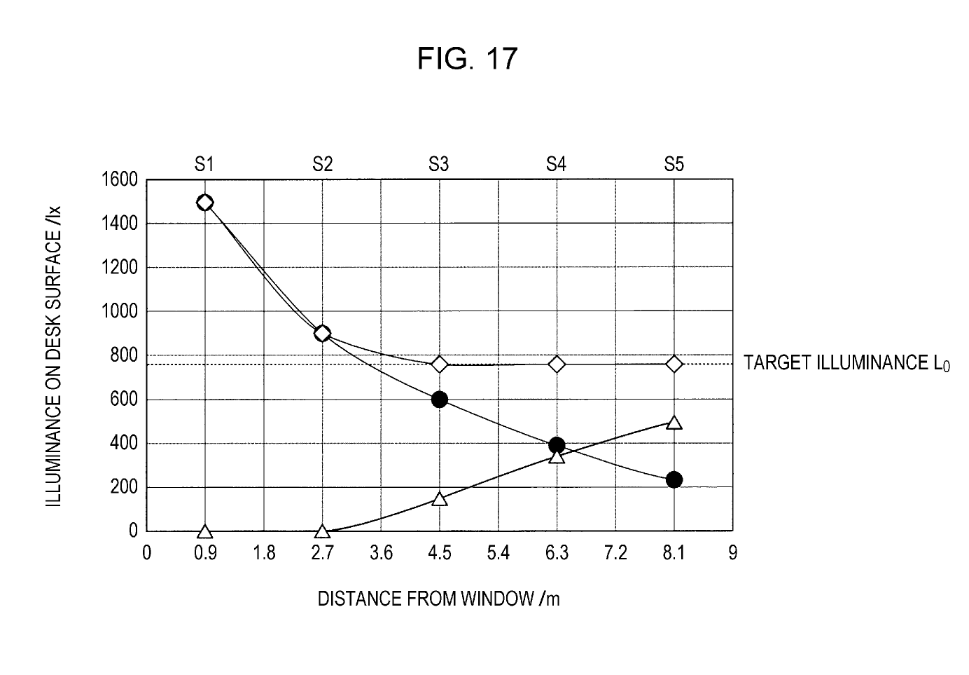

### BRIEF DESCRIPTION OF DRAWINGS

[FIG. 1] FIG. 1 is a perspective view showing a daylighting system of Embodiment 1.

[FIG. 2] FIG. 2 is a view showing an operation of the daylighting system during the daytime.

[FIG. 3] FIG. 3 is a view showing an operation of the daylighting system during the nighttime.

[FIG. 4] FIG. 4 is a perspective view showing a daylighting system of Embodiment 2.

[FIG. 5] FIG. 5 is a view showing an operation of the daylighting system when an adjacent room is bright.

[FIG. 6] FIG. 6 is a view showing an operation of the daylighting system when the adjacent room is dark.

[FIG. 7] FIG. 7 is a view showing a daylighting system of Embodiment 3 and an operation of the daylighting system during the daytime.

[FIG. 8] FIG. 8 is a view showing an operation of the daylighting system during the nighttime.

[FIG. 9] FIG. 9 is a view showing a daylighting system of Embodiment 4 and an operation of the daylighting system when the outside is bright. [FIG. 10] FIG. 10 is a view showing an operation of the daylighting system when the outside is dark.

[FIG. 11] FIG. 11 is a view showing a daylighting system of Embodiment 5 and an operation of the daylighting system during the daytime.

[FIG. 12] FIG. 12 is a view showing an operation of the daylighting system during the nighttime.

[FIG. 13] FIG. 13 is a view showing a daylighting system of Embodiment 6 and an operation of the daylighting system during the daytime.

[FIG. 14] FIG. 14 is a view showing an operation of the daylighting system during the nighttime.

[FIG. 15] FIG. 15 is a view showing a room model including a daylighting apparatus and an illumination light control system, which is a sectional view taken along line J-J′ in FIG. 16.

[FIG. 16] FIG. 16 is a plan view showing a ceiling of the room model.

[FIG. 17] FIG. 17 is a graph showing a relationship between illuminance of light (natural light) taken into the room by the daylighting apparatus and illuminance (illumination light control system) of an indoor illumination appliance.

### DESCRIPTION OF EMBODIMENTS

### Embodiment 1

Hereinafter, Embodiment 1 will be described with reference to FIGS. 1 to 3.

A daylighting system according to Embodiment 1 is one example of the daylighting system which is installed in a window of a building and allows sunlight to be taken into the building.

In the following drawings, in order to make each element easy to see, elements are not necessarily shown to scale, and scales of dimensions may be shown differently depending on elements.

As shown in FIG. 1, the daylighting system 1 according to the embodiment includes a daylighting apparatus 2 and an artificial light source apparatus 3. The daylighting apparatus 2 includes a base material 4, a plurality of daylighting portions 5 provided on a first surface 4a of the base material 4, and a plurality of gap portions 6 provided between the plurality of daylighting portions 5. The daylighting apparatus 2 is attached on a surface of a window glass 7 that faces the outside. The artificial light source apparatus 3 includes a light emitting element 8 and a light guide plate 9. The base material 4 of the daylighting apparatus 2 and the light guide plate 9 of the artificial light source apparatus 3 are arranged substantially in parallel with each other with a predetermined space. That is, a first surface 9a, which is an end surface from which light from the light guide plate 9 emits, and the first surface 4a of the base material 4 are substantially parallel.

As the base material 4 of the daylighting apparatus 2, for example, a light transmissive base material made of a thermoplastic polymer or a resin such as a thermosetting resin, a photopolymerizable resin, or the like is used. The light transmissive base material made of an acrylic polymer, an olefin polymer, a vinyl polymer, a cellulose polymer, an amide polymer, a fluorine polymer, a urethane polymer, a silicone polymer, an imide polymer, or the like is used. Specifically, for example, a light transmissive plate material such as triacetyl cellulose (TAC), polyethylene terephthalate (PET), cycloolefin polymer (COP), polycarbonate (PC), polyethylene naphthalate (PEN), polyethersulfone (PES), polyimide (PI), or the like is preferably used. In addition, the base material 4 may be a glass base material. The base material 4 may have any thickness. The base material 4 may be a stacked structure in which a plurality of materials is stacked on top of each other. The whole light transmittance of the base material 4 may be 90% or more according to JIS K 7361-1. In this way, it is possible to obtain sufficient transparency.

The daylighting portions 5 are fine protrusions of an order of tens to hundreds of micrometers provided on the first surface 4a of the base material 4 so as to introduce light inside. The plurality of daylighting portions 5 are provided in a stripe shape.

The plurality of daylighting portions 5 each extend in the Y direction (horizontal direction) and are disposed in parallel to each other in the Z direction (vertical direction.). The daylighting portion 5 has a polygonal shape in cross-section orthogonal to the longitudinal direction of the daylighting portion 5.

As shown in FIGS. 2 and 3, the daylighting portion 5 is a polygonal pillar-like structure having a pentagonal shape in cross-section and being formed asymmetrically on both sides with respect to a perpendicular line Q of the base material 4 passing through an apex 5b that is farthest from the base material 4. The cross-sectional shape of the daylighting portion 5 is not limited to the shape in the drawings, but can be appropriately changed according to the use of the daylighting apparatus 2.

Air exists in a gap portion 6 between adjacent daylighting portions 5. Therefore, the refractive index of the gap portion 6 is approximately 1.0. By setting the refractive index of the gap portion 6 to 1.0, the critical angle at the interface between the gap portion 6 and the daylighting portion 5 is minimized. In a case where the space in which the daylighting portion 5 is provided is hermetically sealed, the gap portion 6 may be filled with an inert gas, or may be in a state of reduced pressure.

It is desirable that the refractive index of the base material 4 is substantially equal to that of the daylighting portion 5. In a case where the refractive index of the base material 4 and the refractive index of the daylighting portion 5 are greatly different from each other, when light enters the base material 4 from the daylighting portion 5, unnecessary refraction or reflection may occur at the interface between the daylighting portion 5 and the base material 4. In this case, there is a possibility that a desired daylighting characteristic cannot be obtained, which results in reduction in brightness. By setting the refractive indices of the base material 4 and the daylighting portion 5 to be substantially equal to each other, the desired daylighting characteristic can be obtained, the light utilization efficiency increases, and unpleasant reflection light cannot easily enter the inside.

In the daylighting portion 5, for example, an organic material having light transmittance property and photosensitivity, such as an acrylic resin, an epoxy resin, a silicone resin, or the like is included. It is possible to use a mixture of transparent resins obtained by mixing a polymerization initiator, a coupling agent, a monomer, an organic solvent and the like into resins described above. Further, the polymerization initiator may contain various additional components such as a stabilizer, an inhibitor, a plasticizer, a fluorescent whitening agent, a release agent, a chain transfer agent, and other photopolymerizable monomers. The total light transmittance of the daylighting portion 5 is preferably 90% or more according to the JIS K 7361-1 standard. Therefore, sufficient transparency can be obtained.

The artificial light source apparatus 3 includes the light emitting element 8, and the light guide plate 9. Among a plurality of surfaces of the light guide plate 9, a surface facing the daylighting apparatus 2, that is, a surface from which light is emitted is referred to as the first surface 9a. A surface opposite to the first surface 9a, that is, a surface on which light is incident is referred to as a second surface 9b. The planar shape of the light guide plate 9 when viewed from the normal direction of the first surface 9a and the second surface 9b is rectangular. Among the plurality of surfaces of the light guide plate 9, four surfaces other than the first surface 9a and the second surface 9b are referred to as end surfaces. The light guide plate 9 of the present embodiment corresponds to a light guide member in Claims.

The light emitting element 8 is provided on one end surface of the light guide plate 9 with a light emission surface of the light emitting element 8 facing the light guide plate 9. An end surface of the light guide plate 9, on which the light emitting element 8 is provided, is referred to as a first end surface 9c, and an end surface of the light guide plate 9 opposite to the end surface on which the light emitting element 8 is provided is referred to as a second end surface 9d. As the light emitting element 8, for example, a light emitting diode (LED) or a cold cathode tube can be used, but the type of the light emitting element 8 is not limited, The light emitted from the light emitting element 8 enters the inside of the light guide plate 9 from the first end surface 9c, and is guided inside the light guide plate 9.

The light guide plate 9 includes a base material 11 and a plurality of reflection patterns 12 provided on one surface of the base material 11. That is, on the second surface 9b of the light guide plate 9 (light incident end surface), reflection patterns 12 that diffuse and reflect the light guided through the inside of the light guide plate 9 are partially provided. The base material 11 is made of a material, for example, having a high transmittance in the visible light wavelength range, such as a polymethylmethacrylate resin (PMMA). As the material of the base material 11, in addition to the PMMA, the same material as the base material 4 of the daylighting apparatus 2 described above may be used. The plurality of reflection patterns 12 are formed with white ink, and are printed on one surface of the base material 11. The planar shape of the reflection pattern 12 when viewed from the normal direction of the light guide plate 9 is circular, but is not limited to being circular. The area of the reflection pattern 12 gradually increases from the first end surface 9c toward the second end surface 9d.

The reflection pattern 2 of the present embodiment is a reflection portion in Claims.

For example, as the light guide plate 9, a printed light guide plate such as SA Light Guide (registered trademark) of SUMIKA ACRYL CO., LTD. can be used. In addition, in FIGS. 1 to 3, in order to make the drawings easier to view, the reflection pattern 12 is drawn in an enlarged scale, but the actual reflection pattern 12 is a significant fine pattern with respect to the size of the light guide plate 9, and more reflection patterns 12 are provided on the light guide plate 9. The area occupied by the all reflection patterns 12 for the entire area of the second surface 9b of the light guide plate 9 is significantly small, and the base material 11 is exposed in most areas of the second surface 9b.

As shown in FIG. 3, light guided through the inside of the light guide plate 9 travels toward the second end surface 9d while being totally reflected by the first surface 9a and the second surface 9b. However, the light incident on the reflection pattern 12 of the second surface 9b is diffused and reflected by the reflection pattern 12 to travel in all directions. Therefore, the light that has been diffused and reflected by the reflection pattern 12 and then incident on the first surface 9a at an incident angle smaller than the critical angle is emitted from the first surface 9a. In this way, the artificial light source apparatus 3 having this type of light guide plate 9 functions as a planar light emitter. In addition, since the area of the reflection pattern 12 gradually increases from the first end surface 9c to the second end surface 9d, the luminance distribution in the plane of the light guide plate 9 becomes uniform. Since the light emitting element 8 is disposed only on the first end surface 9c of the light guide plate 9, the light emitting direction is inclined toward the second end surface 9d side (lower side in the vertical direction) with respect to the normal direction of the first surface 9a.

Next, operations of the daylighting system 1 according to the present embodiment will be described.

As shown in FIG. 2, during the daytime, natural light L1 directly arriving from the sun 5, enters the daylighting system 1 from the outside, at an oblique angle from above. Most of natural light L1 enters areas other than formation areas of the reflection patterns 12 on the second surface 9b of the light guide plate 9. The natural light L1 that has entered the areas other than the formation areas of reflection patterns 12 on the second surfaces 9b of the light guide plate 9 passes through the light guide plate 9 and travels toward the daylighting apparatus 2. In this case, since the first surface 9a and the second surface 9b of the light guide plate 9 are flat planes that are parallel with each other, the incident angle of the natural light L1 to the daylighting apparatus 2 before the light is incident on the light guide plate 9 is equal to that after the light passes through the light guide plate 9.

The natural light L1 that has arrived at the daylighting apparatus 2 enters the daylighting portions 5. Among surfaces of the plurality of daylighting portions 5, the natural light L1 incident from a light incident end surface 5G that is inclined upward is totally reflected by a reflection surface 5H and travels obliquely upward, and is emitted from an emission surface 5J of the daylighting portion 5. The natural light L1 emitted from the daylighting portion 5 passes through the base material 4 and a window glass 7 and emitted toward the ceiling of the inside. The natural light L1′ emitted from the daylighting apparatus 2 toward the ceiling is reflected by the ceiling to illuminate the interior, which is a substitute for illumination light. In this way, since the interior can be illuminated by using natural light L1 from the sun S during the daytime, the artificial light source apparatus 3 may be turned off.

On the other hand, natural light L2 incident on the reflection pattern 12 on the second surface 9b of the light guide plate 9 from the outside is diffused and reflected by the reflection pattern 12 and travels to the outside, and as a consequence, the light does not enter the inside. Since the reflected light is visually recognized from a person outside, the light L2′ may be formed into patterns, letters, figures, or the like by the reflection pattern 12. In this case, it is possible to impart designability to the appearance of window portions of a building.

Next, as shown in FIG. 3, during the nighttime, since sunlight does not enter the daylighting system 1, the artificial light source apparatus 3 is turned on. Artificial light L3 emitted from the light emitting element 8 travels through the inside of the light guide plate 9 and is diffused and reflected by the reflection pattern 12. The reflected artificial light L3 is emitted from the light guide plate 9. Appropriate adjustment to a light distribution of the light emitting element 8, a scattering characteristic of the reflection pattern 12, or the like, makes it possible to bring the incident angle of the artificial light L3, which is emitted from the light guide plate 9 and is incident on the daylighting apparatus 2, closer to the incident, angle of the natural light L1 (sunlight).

The artificial light L3 incident on the daylighting apparatus 2 is emitted from the daylighting apparatus 2 through substantially the same path as that of the natural light L1 during the daytime. That is, among a plurality of surfaces of the daylighting portion 5, the artificial light L3 incident from the light incident end surface 5G that is inclined upward is totally reflected by the reflection surface 5H and travels obliquely upward, and the traveled light L3 is emitted from the emission surface 5J of the daylighting portion 5. The artificial light L3′ emitted from the daylighting portion 5 passes through the base material 4 and the window glass 7 sequentially and is emitted toward the ceiling of the interior.

The present embodiment described above has been exemplified for the daytime and nighttime. However, the daylighting system 1 of the present embodiment can be applied in the same manner as in the case described above, for example, in a situation in which, even during the same daytime, the interior may be bright or dark depending on the outside environment, such as a fine weather or a rainy weather.

As described above, according to the daylighting system 1 of the present embodiment, the artificial light source apparatus 3 can be turned on such that a predetermined amount of light can be incident on the daylighting apparatus 2 When the outside is bright and even when the outside is dark, thereby making it possible to illuminate the ceiling of the interior. In this way, the daylighting system 1 can be implemented which is capable of suppressing a change in the inside brightness due to a change in outdoor brightness,

As a result, when an illumination design of a building is to be performed, an illumination plan that does not depend on brightness of the outside environment can be established. In addition, as seen from a person inside, even when the outside environment is dark, the area where the daylighting apparatus 2 is installed does not look dark, which makes the impression of a room better.

### Embodiment 2

Hereinafter, Embodiment 2 of the present invention will be described using FIG. 4 to FIG. 6.

A basic configuration of a daylighting system of the present embodiment is the same as that of Embodiment 1, and the area where a daylighting system is installed is different from that of Embodiment 1.

FIG. 4 is a perspective view showing the daylighting system of Embodiment 2. FIG. 5 is a view showing an operation of the daylighting system when an adjacent room is bright. FIG. 6 is a view showing an operation of the daylighting system when the adjacent room is dark.

In FIG. 4 to FIG. 6, the components common to those in the figures used in Embodiment 1 will be denoted as the same reference numerals, and a detailed description thereof will not be repeated.

As shown in FIG. 4, the daylighting system 15 of Embodiment 2 is not provided on the window glass facing the outside, but provided on a partition 16 that separates an adjacent room not facing the outside. In addition, the adjacent room which is referred to in the present specification is not necessarily limited to a room, but may be a common space, for example, a corridor, a lobby or the like. Therefore, the partition 16 does not necessarily have to separate one room from the other room, and it is sufficient if the partition separates any two adjacent spaces in a building.

As shown in FIG. 5 and FIG. 6, the daylighting system 15 includes a daylighting apparatus 2, and an artificial light source apparatus 3. The daylighting apparatus 2 is disposed on a glass plate 17 provided on a part (upper part) of the partition 16. The artificial light source apparatus 3 is disposed on the adjacent room side. The configurations of the daylighting apparatus 2 and the artificial light source apparatus 3 are the same as those in Embodiment 1.

A building 18 of the present embodiment includes the partition 16 that separates two adjacent spaces and the daylighting apparatus 2 provided on a part of the partition 16, The daylighting apparatus 2 includes a base material 4 having light transmission property, and a plurality of daylighting portions 5 that are installed on a first surface of the base material 4, have light transmission property, and reflect light incident from a light incident end surface 5G by a reflection surface 5H.

In the daylighting system 15 of the present embodiment, for example, in a situation where an illumination appliance 19 is being turned on, illumination light L4 from the illumination appliance 19 enters the daylighting system 15 from the outside, at an oblique angle from above, passes through a light guide plate 9, and then travels toward the daylighting apparatus 2, as shown in FIG. 5. The illumination light incident on the daylighting portion 5 of the daylighting apparatus 2 travels obliquely upward by the reflection surface, and is emitted toward the ceiling of the interior. Since the illumination light L4′ emitted from the daylighting apparatus 2 toward the ceiling is reflected by the ceiling and illuminates the interior, the light L4° is substituted for the illumination light. In this way, when the illumination appliance 19 in the adjacent room is being turned on, since the interior can be illuminated using the illumination light 19 from the adjacent room, the artificial light source apparatus 3 can be turned off.

As shown in FIG. 6, when the illumination appliance 19 in the adjacent room is being turned off, the artificial light source apparatus 3 is turned on. The artificial light L3 emitted from the artificial light source apparatus 3 enters the daylighting apparatus 2 through substantially the same path as that of the illumination light L4 from the adjacent room, and is emitted from the daylighting apparatus 2. That is, the artificial light L3 is totally reflected by the reflection surface and travels obliquely upward, and is emitted from the light emission surface of the daylighting portion 5. The artificial light L3′ emitted from the daylighting apparatus 2 passes through the glass plate 17, and is emitted toward the ceiling of the interior.

As described above, according to the daylighting system 15 of the present embodiment, switching of the artificial light source apparatus 3 on and off makes it possible to allow a predetermined amount of light to be incident on the daylighting apparatus 2 without depending on the illumination situation of the adjacent room, which in turn makes it possible to illuminate the ceiling of the interior. In this way, the daylighting system 15 which is capable of suppressing a change in the inside brightness due to a change in the brightness of the adjacent room can be implemented. As a result, when an illumination design of a building is to be performed, an illumination plan that does not depend on the brightness of the outside environment can be established. In addition, as seen from a person M inside, even when the adjacent room is dark, the area where the daylighting apparatus 2 is installed does not look dark, which makes the impression of a room better.

### Embodiment 3

Hereinafter, Embodiment 3 of the present invention will be described using FIG. 7 and FIG. 8.

A basic configuration of a daylighting system of the present embodiment is the same as that of Embodiment 2, and the disposition of an artificial light source apparatus is different from that of Embodiment 2.

FIG. 7 is a view showing an operation of the daylighting system when an adjacent room is bright. FIG. 8 is a view showing an operation of the daylighting system when the adjacent room is dark.

In FIG. 7 and FIG. 8, the components common to those in the figures used in Embodiment 1 will be denoted as the same reference numerals, and a detailed description thereof will not be repeated.

In Embodiment 2, the artificial light source apparatus is disposed such that the light guide plate is substantially parallel with the base material of the daylighting apparatus. However, the light guide plate does not necessarily have to be disposed to be parallel with the base material of the daylighting apparatus. As shown in FIG. 7 and FIG. 8, in the daylighting system 22 of Embodiment 3, the artificial light source apparatus 3 is disposed such that the light guide plate 9 is parallel with a ceiling T. The artificial light source apparatus 3 is disposed such that a light emitting element 8 is located on a far side from the daylighting apparatus 2. The artificial light source apparatus 3 is disposed such that a second surface 9b of the light guide plate 9 provided with a reflection pattern faces upward. In this way, the light guide plate 9 and the daylighting apparatus 2 are in a positional relationship perpendicular to each other. Even when the artificial light source apparatus 3 and the daylighting apparatus 2 are in such a positional relationship, the artificial light L3 from the artificial light source apparatus 3 enters the daylighting apparatus 2 at an incident angle substantially equal to that of the natural light L1 when the adjacent room is bright.

The configurations of the daylighting apparatus 2 and the artificial light source apparatus 3 are the same as those in Embodiment 1.

A diffusion plate 23 is provided on a light emission side of the daylighting apparatus 2. Light emitted from the daylighting apparatus 2 is diffused by the diffusion plate 23 and emitted. This makes illuminance of the room more uniform.

Also in Embodiment 3, it is possible to implement the daylighting system capable of suppressing a change in the inside brightness due to a change in the brightness of the adjacent room, which makes it possible to obtain the same effects as those in Embodiment 1 and Embodiment 2.

In Embodiment 3, it is described that the artificial light source apparatus 3 of the daylighting system 22 is installed on the ceiling T of the adjacent room, but the illumination appliance originally installed on the ceiling of the adjacent room may be used as the artificial light source apparatus of the daylighting system. In any case, a daylighting method includes: in an environment where an adjacent room is bright (first outside environment), taking light from the outside and introducing the light into the inside, using a daylighting apparatus including a base material having light transmission property, and a plurality of daylighting portions that are provided on a first surface of the base material, have light transmission property, and reflect light incident from a light incident end surface on a reflection surface; and when an adjacent room is in a dark environment(second outside environment where the illuminance of the light is lower than the illuminance of the first outside environment), taking light emitted from an artificial light source apparatus and introducing the emitted light into the inside.

### Embodiment 4

Hereinafter, Embodiment 4 of the present invention will be described using FIG. 9 and FIG. 10.

A basic configuration of a daylighting system of the present embodiment is the same as that of Embodiment 3, the area where an artificial light source apparatus is disposed is different from that of Embodiment 2, and the artificial light source apparatus also serves as, for example, a window shield.

FIG. 9 is a view showing an operation of the daylighting system when the outside is bright. FIG. 10 is a view showing an operation of the daylighting system when the outside is dark.

In FIG. 9 and FIG. 10, the components common to those in the figures used in Embodiment 3 will be denoted as the same reference numerals, and a detailed description thereof will not be repeated.

In Embodiment 3, the artificial light source apparatus is disposed such that a light guide plate is parallel with a ceiling of an adjacent room. On the other hand, as shown in FIG. 9 and FIG. 10, in the daylighting system 35 of Embodiment 4, the artificial light source apparatus 3 is provided with a translucent light guide plate 36 which protrudes to the outside of the window (the outside). The artificial light source apparatus 3 is disposed so as to be substantially perpendicular to the base material of the daylighting apparatus 2 and substantially parallel with the ceiling T of the inside. The artificial light source apparatus 3 is disposed so that the light emitting element 8 is positioned on a far side from the daylighting apparatus 2. In addition, the artificial light source apparatus 3 is disposed such that a second surface 36b of the light guide plate 36 provided with a reflection pattern faces upward. In this way, the light guide plate 36 and the daylighting apparatus 2 are in a positional relationship perpendicular to each other. For example, when the outside is dark and the artificial light source apparatus 3 is turned on, such as during the nighttime, the artificial light L3 from the artificial light source apparatus 3 is incident on the daylighting apparatus 2 at an incident angle substantially equal to that of the natural light L1 when the adjacent room is bright.

The configurations of the daylighting apparatus 2 and the artificial light source apparatus 3 is the same s those in Embodiment 1.

A diffusion plate 23 is provided on a light emission side of the daylighting apparatus 2. Light emitted from the daylighting apparatus 2 is diffused by the diffusion plate 23 and emitted. This makes illuminance of the room more uniform.

Also in Embodiment 4, it is possible to implement the daylighting system capable of suppressing a change in the inside brightness due to a change in the brightness of the outside environment, which makes it possible to obtain the same effects as those in Embodiment 1 to Embodiment 3. Furthermore, by installing the artificial light source apparatus 3 at the position of Embodiment 4, the light guide plate 36 can be given a function as an cave when it rains without blocking solar radiation incident on the daylighting apparatus 2.

### Embodiment 5

Hereinafter, Embodiment 5 of the present invention will be described using FIG. 11 and FIG. 12.

A basic configuration of a daylighting system of the present embodiment is the same as that of Embodiment 2, and a configuration of an artificial light source apparatus is different from that of Embodiment 2.

FIG. 11 is a view showing an operation of the daylighting system when an adjacent room is bright. FIG. 12 is a view showing an operation of the daylighting system when the adjacent room is dark.

In FIG. 11 and FIG. 12, the components common to those in the figures used in Embodiment 1 will be denoted as the same reference numerals, and a detailed description thereof will not be repeated.

The daylighting systems of Embodiment 1 to Embodiment 4 have the artificial light source apparatus including the planar light emitter. However, the artificial light source apparatus does not necessarily have to be a planar light emitter. As shown in FIG. 11 and FIG. 12, the daylighting system 26 of Embodiment 5 includes an artificial light source apparatus 27 capable of emitting light having directivity, such as a spotlight. The artificial light source apparatus 27 is installed such that the traveling direction of the artificial light L5 emitted from the artificial light source apparatus 27 and traveling toward the daylighting apparatus 2 substantially matches the traveling direction of the natural light L1.

The configuration of the daylighting apparatus 2 is the same as those in Embodiment 1 to Embodiment 4.

Also in Embodiment 5, it is possible to implement the daylighting system capable of suppressing a change in the inside brightness due to a change in the brightness of the adjacent room, Which makes it possible to obtain the same effects as those in Embodiment 1 to Embodiment 4.

### Embodiment 6

Hereinafter, Embodiment 6 of the present invention will be described using FIG. 13 and FIG. 14.

A basic configuration of a daylighting system of the present embodiment is the same as that of Embodiment 2, and a configuration of an artificial light source apparatus is different from that of Embodiment 2.

FIG. 13 is a view showing an operation of the daylighting system when an adjacent room is bright. FIG. 14 is a view showing an operation of the daylighting system when the adjacent room is dark.

In FIG. 13 and FIG. 14, the components common to those in the figures used in Embodiment 1 will be denoted as the same reference numerals, and a detailed description thereof will not be repeated.

The daylighting systems of Embodiment 1 to Embodiment 4 have the artificial light source apparatus including the planar light emitter. The daylighting system of Embodiment 5 has the artificial light source apparatus including a directional light source. However, the artificial light source apparatus does not necessarily have to be a planar light emitter or a directional light source. As shown in FIG. 13 and FIG. 14, the daylighting system 30 of Embodiment 6 includes an artificial light source apparatus 31 including a general light source such as a ceiling light. For example, the artificial light source apparatus 31 may be installed at a position higher than the ceiling T of the inside as needed such that the natural light LI during the daytime can easily enter the daylighting apparatus 2.

The configuration of the daylighting apparatus 2 is the same as those in Embodiment 1 to Embodiment 5.

Also in Embodiment 6, it is possible to implement the daylighting system capable of suppressing a change in the inside brightness due to a change in the brightness of the adjacent room, which makes it possible to obtain the same effect as those in Embodiment 1 to Embodiment 5.

### Illumination Light Control System

FIG. 15 is a view showing a room model including a daylighting apparatus and an illumination light control system, which is a sectional view taken along line J-J′ in FIG. 16, FIG. 16 is a plan view showing a ceiling of the room model 2000.

In the room model 2000, a ceiling material forming a ceiling 2003a of a room 2003 into which external light is introduced may have high light reflectivity. As shown in FIG. 15 and FIG. 16, the ceiling 2003a of the room 2003 is provided with a light reflective ceiling material 2003A as the light reflective ceiling material. The light reflective ceiling material 2003A is intended to promote the introduction of the external light from the daylighting apparatus 2010 installed in a window 2002 toward an inner side of the room, and so is installed on the window side of the ceiling 2003a. Specifically, the light reflective ceiling material 2003A is installed in a predetermined area E (area of approximately 3 m from the window 2002) of the ceiling 2003a.

As described above, the light reflective ceiling material 2003A serves to effectively guide external light introduced to the interior through the window 2002 in which the daylighting apparatus 2010 (one daylighting apparatus of embodiments described above) is installed to the inner side of the room. The external light introduced from the daylighting apparatus 2010 toward the ceiling 2003a of the inside of the room is reflected by the light reflective ceiling material 2003A and changes the direction to illuminate a desk surface 2005a of a desk 2005 positioned on the inner side of the room, thereby exhibiting the effect of brightening the desk surface 2005a.

The light reflective ceiling material 2003A may be a diffuse reflective material or mirror reflective material, but, it is desirable to appropriately mix both the characteristics such that the effect of brightening the desk surface 2005a of the desk 2005 positioned on the inner side of the room is compatible with the effect of suppressing glare light causing a person inside to feel unpleasant.

In this way, much of the light introduced into the inside by the daylighting apparatus 2010 travels toward the ceiling in the vicinity of the window 2002, and so in many cases the amount of light is significant in the vicinity of the window 2002. For this reason, by using the light reflective ceiling material 2003A together, it is possible to distribute light incident on the ceiling in the vicinity of the window area E) to the inner side of the room where the amount of light is small compared to the window side.

The light reflective ceiling material 2003A can be produced by embossing a metal plate such as aluminum with concavities and convexities of approximately several tens of micrometers, depositing a metal thin film such as aluminum on a resin substrate on which similar concavities and convexities are formed, and so on. Alternatively, concavities and convexities by embossing may be formed on a curved surface with a larger period.

Furthermore, by appropriately changing the emboss shape formed on the light reflective ceiling material 2003A, it is possible to control light distribution characteristics of light and distribution of light of the inside. For example, when the material is embossed in a stripe shape which extends to the inner side of the room, the light reflected by the light reflective ceiling material 2003A is diffused in a left-right direction of the window 2002 (direction intersecting with the length direction of the concavities and convexities). When the size and direction of the window 2002 of the room 2003 are limited, by using the property, the light can be diffused in a horizontal direction by the light reflective ceiling material 2003A, and can be reflected toward the inner side of the room.

The daylighting apparatus 2010 is used as a part of the illumination light control system of the room 2003. The illumination light control system is configured with all component members including, for example, the daylighting apparatus 2010, a plurality of indoor illumination apparatuses 2007, a solar radiation adjustment apparatus 2008 installed in the window, a control system thereof, and the light reflective ceiling material 2003A installed on the ceiling 2003a.

In the window 2002 of the room 2003, the daylighting apparatus 2010 is installed on the upper side, and the solar radiation adjustment apparatus 2008 is installed on the lower side. Here, a blind is installed as the solar radiation adjustment apparatus 2008, but it is not limited to the blind.

In the room 2003, the plurality of indoor illumination apparatuses (illumination apparatuses) 2007 are disposed in a lattice pattern in a left-right direction of the window 2002 (Y direction) and an inside direction of the room (X direction). The plurality of indoor illumination apparatuses 2007 constitutes the entire illumination system of the room 2003 together with the daylighting apparatus 2010.

As shown in FIG. 15 and FIG. 16, the ceiling 2003a of an office having a length L₁ of 18 m in the left-right direction (Y direction) of the window 2002 and a length L₂ of 9 m in the inside direction (X direction) of the room 2003 is shown. Here, the indoor illumination apparatuses 2007 are disposed in the lattice pattern each at an interval P of 1.8 m in the lateral direction (Y direction) and the inside direction (X direction) of the ceiling 2003a. More specifically, 50 indoor illumination apparatuses 2007 are disposed in ten rows (Y direction) and five columns (X direction).

The indoor illumination apparatus 2007 includes an indoor illumination appliance 2007a, a brightness detector 2007b, and a controller 2007c, and is configured by integrating the indoor illumination appliance 2007a, the brightness detector 2007b, and the controller 2007c.

The indoor illumination apparatus 2007 may have a plurality of indoor illumination appliances 2007a and a plurality of brightness detectors 2007b. However, one brightness detector 2007b is provided for each indoor illumination appliance 2007a. The brightness detector 2007b receives the reflected light of an irradiated surface illuminated by the indoor illumination appliance 2007a, and detects the illuminance of the irradiated surface. Here, the illuminance of the desk surface 2005a of the desk 2005 positioned on the inside is detected using the brightness detector 200b.

The controllers 2007c, of which one is provided for each indoor illumination apparatus 2007, are connected to each other. The indoor illumination apparatus 2007 performs feedback control of adjusting light output of an LED lamp of each indoor illumination appliance 2007a by the controllers 2007c connected to each other, such that the illuminance on the desk surface 2005a detected by each brightness detector 2007b becomes a constant target illuminance Lo (for example, average illuminance 750 lx).

FIG. 17 is a graph showing a relationship between illuminance of light (natural light) taken into the room by the daylighting apparatus and illuminance (illumination light control system) of an indoor illumination apparatus.

The vertical axis of FIG. 17 shows illuminance on a desk surface (lx), and the horizontal axis shows the distance (m) from the window. In addition, the broken line in the figure shows the target illuminance of the inside (●: illuminance by daylighting apparatus, Δ: illuminance by indoor illumination apparatus, and ⋄: total illuminance).

As shown in FIG. 17, the illuminance on the desk surface resulting from light which has been taken by the daylighting apparatus 2010 is brighter in the vicinity of the window, and the effect is reduced as the distance from the window increases. In a room to which the daylighting apparatus 2010 is applied, an illuminance distribution in the direction toward an inner side of the room is generated as described above by natural daylighting from the window during the daytime. Therefore, the daylighting apparatus 2010 is used together with the indoor illumination apparatus 2007 that compensates for the illuminance distribution of the interior. Each of the indoor illumination apparatuses 2007 installed on the ceiling of the interior detects an average illuminance under the appliance with each of the brightness detectors 2007b, and is turned on by light control such that the illuminance on the desk surface of the entire room becomes the constant target illuminance L0. Therefore, rows S1 and S2 disposed in the vicinity of the window are hardly turned on, and rows S3, S4 and S5 are turned on with a higher intensity along the direction toward the inner side of the room. As a result, the desk surface in the room is illuminated by the sum of the illuminance by natural daylighting and illuminance by the indoor illumination apparatus 2007, and it is possible to implement 750 lx (recommended maintenance illuminance in the office of “JIS 29110 Lighting General Rules”), which is the illuminance on the desk surface sufficient for office work throughout the room.

As described above, when the daylighting apparatus 2010 and the illumination light control system (indoor illumination apparatus 2007) are used together, light can be delivered further to the inner side, and thus it is possible to further improve the brightness of the interior and also to secure illuminance on the desk surface enough for office work throughout a room. Therefore, more stable bright light environment can be obtained without being influenced by the season and the weather.

The technical scope of the present invention is not limited to the embodiments described above, and various changes can be made without departing from the scope of the present invention.

For example, although a configuration in which the light emitted from the artificial light source apparatus is directly incident on the daylighting apparatus has been illustrated in the embodiments described above, an optical member, for example, a prism sheet may be inserted between the artificial light source apparatus and the daylighting apparatus. This facilitates the adjustment for matching the incident angle of artificial light incident on the daylighting apparatus from the artificial light source apparatus to the incident angle of natural light.

Besides, specific description such as the shape, placement, number, material, or the like of the components configuring the daylighting system are not limited to the embodiments described above, and appropriate modifications can be made.

### INDUSTRIAL APPLICABILITY

Some aspects of the present invention are applicable to a daylighting system, a daylighting method, and a building having a lighting function.

### REFERENCE SIGNS LIST

1, 15, 22, 26, 30, 35 daylighting system
2 daylighting apparatus
3, 27, 31 artificial light source apparatus
4 base material
5 daylighting portion
8 light emitting element
9 light guide plate (light guide member)
12 reflection pattern (reflection portion)
16 partition
18 building

1. A day lighting system comprising:
a daylighting apparatus; and
an artificial light source apparatus that emits light toward the daylighting apparatus,
wherein the daylighting apparatus includes a base material having light transmission property, and a plurality of daylighting portions that are provided on a first surface of the base material, have light transmission property, and reflect light incident from a light incident end surface on a reflection surface, and
wherein the artificial light source apparatus emits at least light that enters the daylighting portions from the light incident end surface and travels toward the reflection surface.

2. The daylighting system according to claim 1, wherein the artificial light source apparatus emits light having directivity.

3. The daylighting system according to claim 2, wherein the artificial light source apparatus includes a planar light emitter.

4. The daylighting system according to claim 3,
wherein the planar light emitter includes a light emitting element, and a light guide member that causes natural light or illumination light to be transmitted and that causes light emitted from the light emitting element to be incident from a light incident end surface, to be guided through an inside of the light guide member, and to be emitted from a light emission end surface, and
wherein the light emission end surface of the light guide member is substantially parallel with the first surface of the base material.

5. The daylighting system according to claim 4, wherein a reflection portion that diffuses and reflects the light guided through the inside of the light guide member is partially provided on a surface of the light guide member opposite to the light emission end surface.

6. The daylighting system according to claim 4, wherein the light guide member is provided to protrude outdoors in a direction substantially perpendicular to the base material.

7. A daylighting method comprising:
in a first outside environment, taking light from outdoors and introducing the light into an interior, using a daylighting apparatus including a base material having light transmission property, and a plurality of daylighting portions that are provided on a first surface of the base material, have light transmission property, and reflect light incident from a light incident end surface on a reflection surface; and
when an illuminance of the light is an illuminance of a second outside environment, which is lower than an illuminance of the first outside environment, taking light emitted from an artificial light source apparatus and introducing the emitted light into the interior.

8. A building comprising:
a partition that partitions an interior into two adjacent spaces; and
a daylighting apparatus installed on a part of the partition,
wherein the daylighting apparatus includes a base material having light transmission property, and a plurality of daylighting portions that are provided on a first surface of the base material, have light transmission property, and reflect light incident from a light incident end surface on a reflection surface.
